(19) United States
(12) Patent Application Publication
(10) Pub. No.: US 2010/0131930 A1
(43) Pub. Date: May 27, 2010

(54) Selective Code Coverage Instrumentation

(75) Inventors: Yochai Ben-Chaim, Haifa (IL); Lawrence Carter Blount, Tucson, AZ (US); Hana Chockler, Haifa (IL); Eitan Farchi, Pardes Hana (IL); Orna Raz-Pelleg, Haifa (IL); Aviad Zlotnick, Mitzpeh Netofah (IL)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/276,077

(22) Filed: Nov. 21, 2008

(51) Int. Cl. G06F 11/36

(52) U.S. Cl. 717/127

(57) ABSTRACT

Reporting on software test coverage, where a set of coverage tasks and a coverage task hierarchy have been established for a software under test (SUT). Establishing a coverage task subset, the subset including at least one coverage task hierarchy element at a level above the lowest coverage task hierarchy level. Identifying when, during a software test, a coverage task in the coverage task subset was completed. Outputting to a user the identity of those portions of the coverage task that have been completed. Refining the coverage task subset in one of the following fashions through the coverage task hierarchy in accordance with user input: depth first progression, breadth first progression.

### BACKGROUND OF THE INVENTION

1. Field of the Invention

This invention relates to technology for providing selective code coverage when monitoring the extent of software testing.

2. Description of Background

It is desirable to measure code coverage with minimal impact on the performance of the system under test (SUT) from instrumentation, e.g., lines of code used to measure coverage. This is especially true, for example, when exercising software in a similar manner to its operation at the customers' system-level test. Using self modifying code coverage instrumentation code is one way to tackle this issue. However, it may not be possible to use self-modifying code or it may be desirable to use self-modifying code sparsely. Often such limitations are due to the difficulties in validating a system with self-modifying code.

### SUMMARY OF THE INVENTION

The technology includes computer program products on a computer usable medium with code, where a set of coverage tasks and a coverage task hierarchy have been established for a software under test (SUT), code for establishing coverage task subset for instrumentation. The subset includes at least one coverage task hierarchy element at a level above the lowest coverage task hierarchy level. The technology further includes code for identifying when, during a software test, a coverage task in the coverage task subset for instrumentation was completed, code for outputting to a user the identify of those portions of the coverage task that have been completed; and code for refining the coverage task subset for instrumentation in one of the following fashions through the coverage task hierarchy in accordance with user input: depth first progression, breadth first progression. The technology may take advantage of self-modifying code but it does not require self-modifying code. Moreover, the technology supports non-homogeneous code coverage—it enables directing more attention to some parts of the code.

Additional features and advantages are realized through the techniques of the technology. Other embodiments and aspects of the technology are described in detail herein and are considered a part of the claimed invention. For a better understanding of the technology with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the technology are apparent from the following detailed description taken in conjunction with the accompanying drawings in which:

FIG. 1 illustrates a method of the technology.

### DETAILED DESCRIPTION OF THE INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Because the purpose of coverage analysis is to improve testing it is useful to not only provide information about parts in the code that are not covered but also to direct attention to uncovered parts that might be risky. The technology supports this by, for example, providing more coverage information about parts that are related to specific concerns.

U.S. patent application Ser. No. 12/058,779 Evaluation of Software Based on Review History, filed Mar. 31, 2008 and U.S. patent application Ser. No. 12/058,774 Evaluation of Software Based on Change History, filed Mar. 31, 2008 (both incorporated herein by reference in their entirety) disclose different ways to prioritize coverage tasks for further investigations and may also be used as a way to selectively reduce performance overhead by partial coverage instrumentation. However, in addition to providing a novel technique to selectively instrument the code for coverage purposes, the current technology supports both non-homogeneous coverage and full fine grain coverage (the latter over multiple runs).

The technology provides ways to obtain finer grain coverage while maintaining and controlling performance impact. By changing the selection over time, e.g., after test runs through the system under test, full fine grain coverage can be achieved with a very small impact on performance. Coverage during any particular run can be non-homogeneous and be directed according to some other goals, e.g., portions of the system-under-test that are of concern.

Embodiments of the technology take advantage of user feedback, e.g., between test runs, to focus coverage reporting on subsequent runs. If there is a requirement for having only a single version of the application to test (e.g., cannot recompile for each test; this is often a demand for system test, for example) and for this version to run “indefinitely,” e.g., it is undesirable to incur off-load time to make changes to the application, then self-modifying code is a reasonable choice.

In some embodiments, a coverage task set (e.g., statements) is given as a starting point. When the coverage task is completed, then the system-under-test is considered 100% covered. A coverage partition is created. The partition can be a hierarchy. Going down the layers the hierarchy is refined. Example—the basic coverage tasks are statement coverage. Higher level elements in the hierarchy include functions, files, libraries.

Other example of partition are based on function calls. A partition can be identified by the number of incoming edges to the function (functions are in the same level if they have the same number of incoming edges). A hierarchy/network based on a call graph can also be used where the hierarchy/network is the partition of coverage tasks.

Given elements in the partition that together encompass the entire coverage task the performance and coverage of each element is checked. If the performance is okay and the element is covered elements that are at high levels of the hierarchy can be refined to the next lower level. That is, the technology selectively measures finer grain coverage.

The coverage task set for the hierarchy may vary, e.g., code structure: directories or libraries, files (normalized by size), functions, and statements summarizing/abstracting coverage records before writing. For example, for a given function only function coverage is required but you are actually taking statement coverage. If all of the information is recorded, that could be an issue. Instead, the data is summarizes in an incore data structure and only the fact that the function was covered or not (it was covered in this case if, and only if, at least one statement in that function was covered) is printed.

There are multiple ways to select coverage tasks for finer grain coverage. For example, Option 1: Further refine the higher level elements until we get to the lowest level, then go to another higher level element and refine it, e.g., depth first progression (DFP).

Option 2: Measure finer grain coverage in different places at different times. For example, start with all the element of that are highest in the hierarchy. Every round refine one of these elements to the next lower level in the hierarchy and leave the rest at the current level breadth first progression (BFP).

For example, referring to FIG. 2, assume that we have 12 statements {s1, . . . , s12}. and functions f1, . . . , f6 where: f1 contains the statements s1 and s2; f2 contains the statements s3 and s4; f3 contains the statements s5,s6,s7; f4 contains the statements s8; f5 contains the statements s9; f6 contains the statements s10, s11, s12; functions f1, and f2 are contained in FILE1; functions f3, and f4 are contained in FILE2; functions f5, f6 are contained in FILE3; and Files FILE1, FILE2 and FILE3 create the library.

Further referring to FIG. 2, assume that the current coverage model is FILE1, f3, f4 and FILE3 (210) providing at least one coverage task element at a level above the lowest coverage task hierarchy level. Next assume that after a first test run performance is OK, and FILE1 is covered, then Referring to FIG. 3, we switch to a finer coverage granularity f1, f2, f3, f4, FILE3 (310). Further assume that performance is OK and f3 is covered and FILE3 is covered.

Referring to FIG. 4, in a first option using DFP the technology refines f3, e.g. the coverage instrumentation 410 switches to f1, f2, s5, s6, s7, f4, FILE3, etc.

Referring to FIG. 5, in a second option using BFP the technology refines FILE3, e.g., the coverage instrumentation 510 switches to f1, f2, f3, f4, f5, f6, etc.

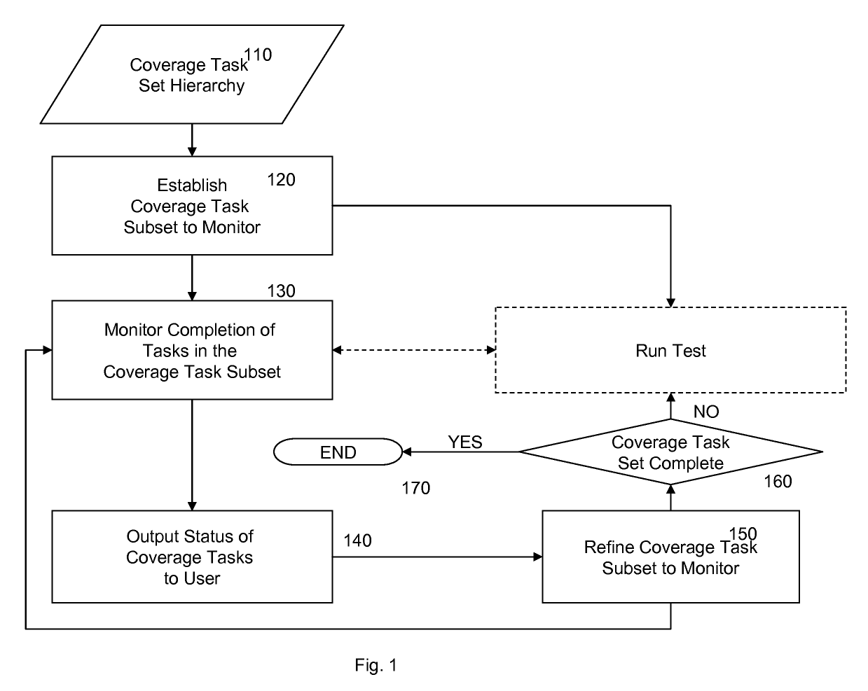

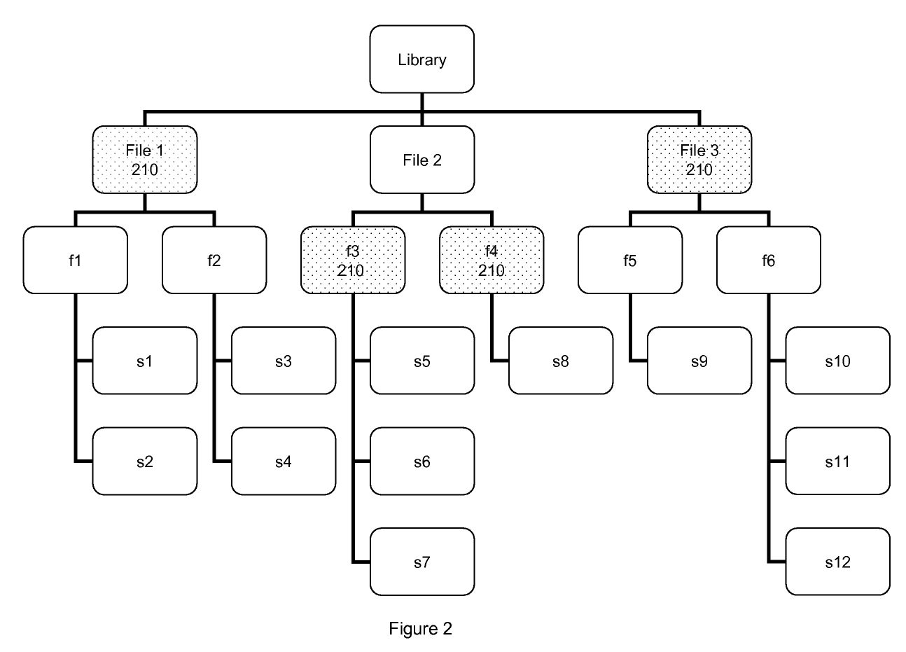

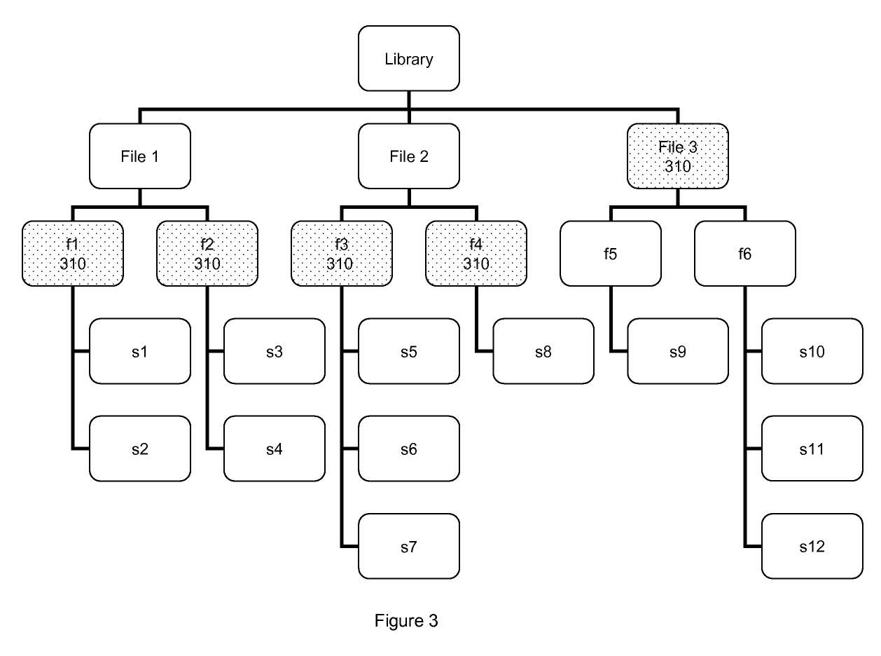

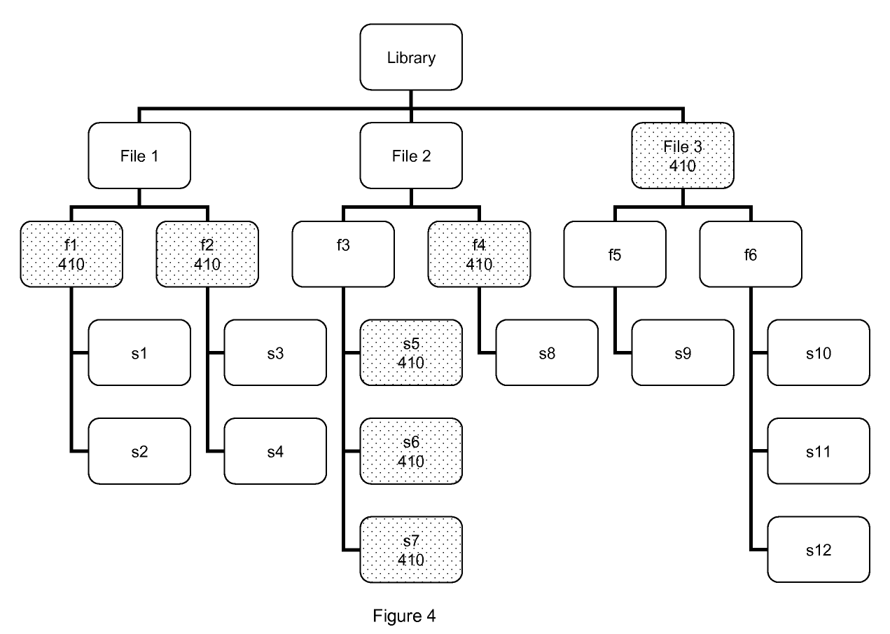

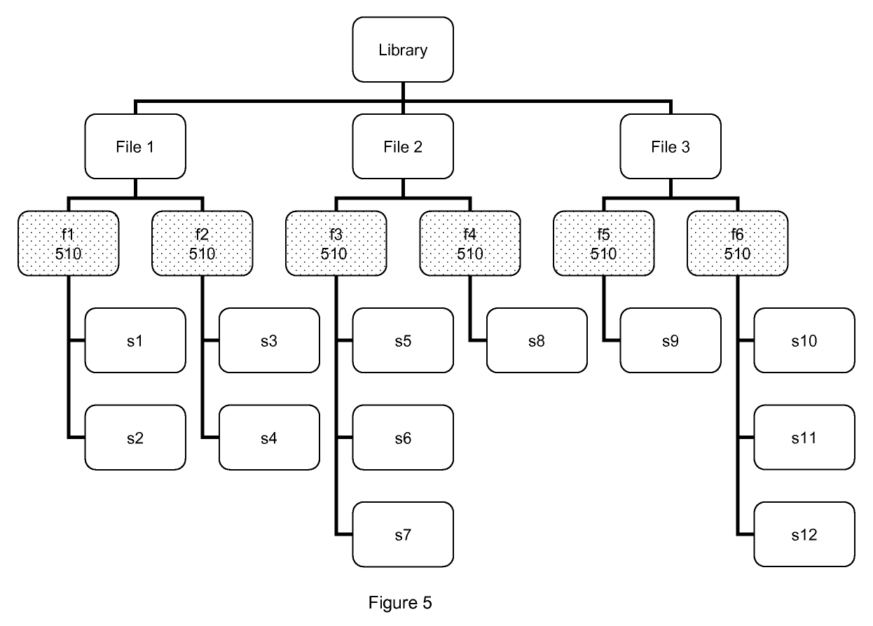

Referring to FIG. 1, in some embodiments, the technology includes a computer program product for reporting on software test coverage, where a set of coverage tasks and a coverage task hierarchy 110 have been established for a software under test (SUT). In those embodiments, computer usable program code allows a user to establish a coverage task subset for instrumentation 120. The subset includes at least one coverage task hierarchy element at a level above the lowest coverage task hierarchy level. The technology further includes computer usable program code for identifying when, during a software test, a coverage task in the coverage task subset for instrumentation was completed 130. The status of coverage tasks is output to a user 140, e.g. the identity of those portions of the coverage task that have been completed are identified. The technology further includes computer usable program code for refining the coverage task subset for instrumentation 150 in one of the following fashions through the coverage task hierarchy in accordance with user input: depth first progression, breadth first progression. If the coverage task set is complete 160, then the test is ended 170. If the coverage task set is not complete, then the test is run again and monitored 130.

The technology can take the form of an entirely hardware embodiment, an entirely software embodiment or an embodiment containing both hardware and software elements. In one embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. For the purposes of this description, a computer usable or computer-readable medium does not include paper.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A computer program product for reporting on software test coverage, where a set of coverage tasks and a coverage task hierarchy comprising a plurality of coverage task hierarchy levels including a highest coverage task hierarchy level and a lowest coverage task hierarchy level have been established for software under test (SUT), the computer program product comprising:
a physical computer-readable medium including:
computer usable program code for establishing coverage task subset for instrumentation, the subset including at least one coverage task element at a level above the lowest coverage task hierarchy level of the coverage task hierarchy;
computer usable program code for identifying when, during a software test, a coverage task element in the coverage task subset for instrumentation was completed;
computer usable program code for outputting to a user the identity of those portions of the coverage task subset for instrumentation that have been completed; and
computer usable program code for refining the coverage task subset for instrumentation in one of the following fashions through the coverage task hierarchy in accordance with user input: depth first progression, breadth first progressions,
wherein each coverage task element at the highest coverage task hierarchy level comprises more code coverage than coverage task elements at lower coverage task hierarchy levels, and
wherein in each of the depth first progression and the breadth first progression comprises refining the coverage task subset for instrumentation starting with a coverage task element at the highest coverage task hierarchy level and ending with a coverage task element at the lowest coverage task hierarchy level.
